(19) United States
(12) Patent Application Publication
(10) Pub. No.: US 2013/0017465 A1
(43) Pub. Date: Jan. 17, 2013

(54) LEAKAGE DIAGNOSTIC FOR A FUEL CELL SYSTEM IN IDLE-STOP MODE

(71) Applicants: Daniel I. Harris, Honeoye Falls, NY (US); Sergio E. Garcia, Webster, NY (US); Brian McMurrough, Honeoye Falls, NY (US)

(72) Inventors: Daniel I. Harris, Honeoye Falls, NY (US); Sergio E. Garcia, Webster, NY (US); Brian McMurrough, Honeoye Falls, NY (US)

(73) Assignee: GM GLOBAL TECHNOLOGY OPERATIONS LLC, DETROIT, MI (US)

(21) Appl. No.: 13/180,270

(22) Filed: Jul. 11, 2011

(51) Int. Cl. H01M 8/04

(52) U.S. Cl. 429/429; 429/428; 429/444

(57) ABSTRACT

A method for determining if more hydrogen has been added to a fuel cell system than a predetermined threshold amount to detect leaks in an anode subsystem or a cathode subsystem of a fuel cell system. The method includes determining a quantity of hydrogen added to the fuel cell system for a given period of time during a predetermined operating condition of the fuel cell system and determining whether the quantity of hydrogen added is more than the predetermined threshold amount. The method also includes adapting an anode subsystem reactant gas concentration model if the quantity of hydrogen added to the fuel cell system is more than the predetermined threshold amount to provide precise control of pressure in the anode subsystem and the cathode subsystem of the fuel cell system.

### BACKGROUND OF THE INVENTION

1. Field of the Invention

This invention relates generally to a method for detecting leaks in an anode subsystem or a cathode subsystem of a fuel cell system and, more particularly, to a method for determining if a greater than expected amount of hydrogen has been added to the fuel cell system for the purpose of detecting leaks in an anode subsystem or a cathode subsystem.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

A fuel cell stack typically includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The MEAs are permeable and thus allow nitrogen in the air from the cathode side of the stack to permeate therethrough and collect in the anode side of the stack, referred to in the industry as nitrogen cross-over. Even though the anode side pressure may be slightly higher than the cathode side pressure, cathode side partial pressures will cause oxygen and nitrogen to permeate through the membrane. The permeated oxygen reacts in the presence of the anode catalyst, but the permeated nitrogen in the anode side of the fuel cell stack dilutes the hydrogen. If the nitrogen concentration increases above a certain percentage, such as 50%, the fuel cell stack may become unstable and may fail.

It is known in the art to provide a bleed valve at the anode exhaust gas output of the fuel cell stack to remove nitrogen from the anode side of the stack. It is also known in the art to estimate the molar fraction of nitrogen in the anode side using a model to determine when to perform the bleed of the anode side or anode sub-system. However, the model estimation may contain errors, particularly as degradation of the components of the fuel cell system occurs over time. If the anode nitrogen molar fraction estimation is significantly higher than the actual nitrogen molar fraction, the fuel cell system will vent more anode gas than is necessary, i.e., will waste fuel. If the anode nitrogen molar fraction estimation is significantly lower than the actual nitrogen molar fraction, the system will not vent enough anode gas and may starve the fuel cells of reactants, which may damage the electrodes in the fuel cell stack.

When electricity is not being drawn from a fuel cell system during an idle-stop mode, air flow through the cathode side of a fuel cell stack is restricted by a valve or valves that operate to regulate air flow and pressure in the cathode side of the stack. A hydrogen-rich anode concentration in the anode side of the stack must also be maintained during the idle-stop mode. If sufficient hydrogen is not supplied to the anode side of the fuel cell stack, oxygen that is present in the cathode side of the stack may diffuse to the anode side through the membranes of the stack, which can lead to corrosion of the cathode electrode due to formation of a hydrogen-air front on the anode side. To prevent oxygen accumulation on the anode side of the stack, and also to prevent hydrogen accumulation on the cathode side of the stack, precise control of the anode side and the cathode side reactants is critical. Thus, there is a need in the art to determine if there are leaks in the fuel cell system that would prevent precise control of the anode side and cathode side reactants.

### SUMMARY OF THE INVENTION

The present invention discloses a method for determining if more hydrogen has been added to a fuel cell system than a predetermined threshold amount to detect leaks in an anode subsystem or a cathode subsystem of the fuel cell system. The method includes determining a quantity of hydrogen added to the fuel cell system for a given period of time during a predetermined operating condition of the fuel cell system and determining whether the quantity of hydrogen added is more than the predetermined threshold amount. The method also includes adapting an anode subsystem reactant gas concentration model if the quantity of hydrogen added to the fuel cell system is more than the predetermined threshold amount to provide precise control of pressure in the anode subsystem and the cathode subsystem of the fuel cell system.

Additional features of the present invention will become apparent from the following description and appended claims, taken in conjunction with the accompanying drawings.

### BRIEF DESCRIPTION OF THE DRAWINGS

FIG. 1 is a simplified block diagram of a fuel cell system;

FIG. 2 is a flow chart diagram of an algorithm for determining if there is a leak in the fuel cell system; and

FIG. 3 is a graph with time in stand-by mode on the horizontal axis and the inverse rate fuel consumption on the vertical axis, illustrating how an algorithm may determine whether there is a leak in the fuel cell system that needs to be addressed.

### DETAILED DESCRIPTION OF THE EMBODIMENTS

The following discussion of the embodiments of the invention directed to a system and method for determining if there is a leak in a fuel cell system is merely exemplary in nature, and is in no way intended to limit the invention or its applications or uses.

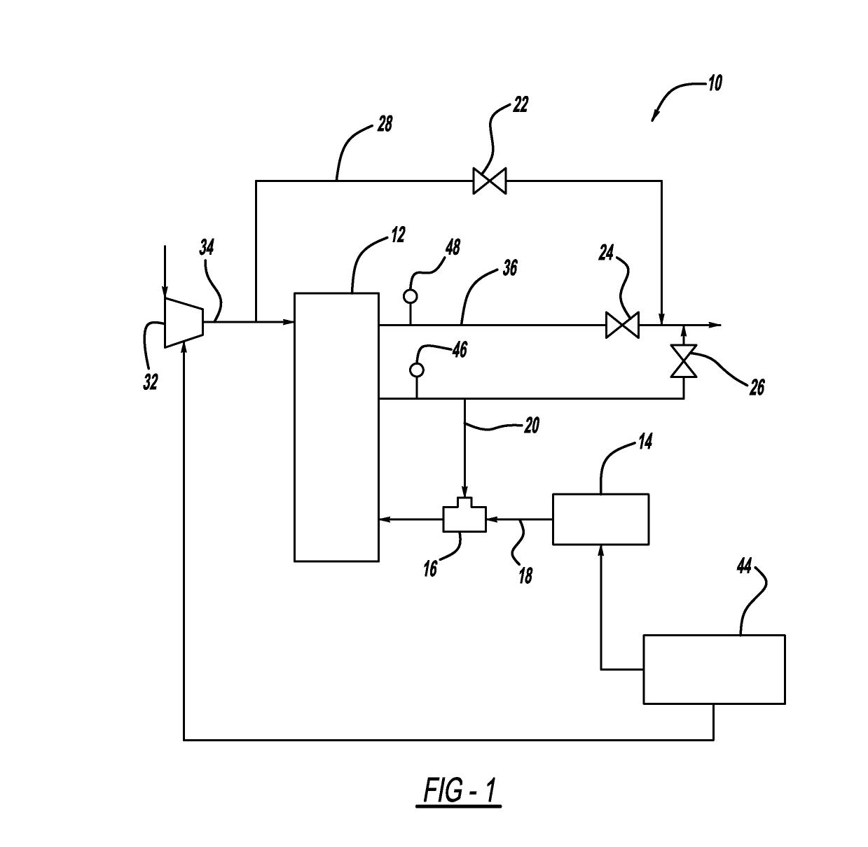

FIG. 1 is a simplified block diagram of a fuel cell system 10 including a fuel cell stack 12. Hydrogen gas from a hydrogen source 14 is provided to the anode side of the fuel cell stack 12 on an anode input line 18 by an injector 16, such as by an injector/ejector, as described in U.S. Pat. No. 7,320,840 entitled, “Combination of Injector-Ejector for Fuel Cell Systems,” issued Jan. 22, 2008, assigned to the assignee of this application and incorporated herein by reference. An anode effluent gas provided at an output of the anode side of the stack 12 is routed back into the fuel cell stack 12 on an anode recirculation line 20. The anode input line 18, the injector 16, the anode side of the stack 12 and the anode recirculation line 20 are all components that make up an “anode subsystem,” and the anode input line 18 and the anode recirculation line 20 make up an “anode loop” as is known to those skilled in the art. Nitrogen cross-over from the cathode side of the fuel cell stack 12 dilutes the hydrogen in the anode side of the stack 12, thereby affecting fuel cell stack performance. Therefore, it is necessary to periodically bleed the anode effluent gas from the anode subsystem using a bleed valve 26 to reduce the amount of nitrogen in the anode subsystem, i.e., in the anode side of the fuel cell stack 12. A temperature sensor 46 is included in the anode recirculation line 20 to monitor the temperature of the anode subsystem.

Air from a compressor 32 is provided to the cathode side of the fuel cell stack 12 on cathode input line 34. A cathode exhaust gas is output from the fuel cell stack 12 on a cathode exhaust gas line 36, where the cathode exhaust gas line 36 includes a backpressure valve 24 to control the pressure in the fuel cell stack 12. A cathode bypass line 28 with a valve 22 connects the cathode input line 34 to the cathode exhaust gas line 36, thereby allowing cathode air to bypass the fuel cell stack 12. The cathode input line 34, the cathode side of the stack 12, the cathode bypass line 28 and the cathode exhaust gas line 36 are all part of a “cathode subsystem.” Bled anode exhaust gas is routed to the cathode exhaust gas line 36 to be removed from the anode subsystem. In other embodiments, bled anode exhaust gas may be routed to the cathode input line 34, although not shown for the sake of clarity. A temperature sensor 48 is included in the cathode gas line 36 to monitor the temperature of the cathode subsystem.

A controller 44 monitors the temperature and pressure of the anode subsystem and the cathode subsystem of the fuel cell system 10, controls the speed of the compressor 32, controls the injection of hydrogen from the injector 16 to the anode side of the stack 12, controls the position of the cathode valve 22 and the backpressure valve 24, and controls the position of the anode bleed valve 26, as is discussed in more detail below.

In a fuel cell system, the anode side and the cathode side of the fuel cell stack 12 are separated by an anode electrode, a polymer electrolyte membrane (similar to Nafion) and a cathode electrode. The purpose of the membrane is to block the transport of gases between the anode side and the cathode side of the fuel cell stack 12 while allowing the transport of protons to complete the anodic and cathodic reactions on their respective electrodes, as is known to those skilled in the art. While the membrane inhibits gas diffusion sufficiently for efficient operation of the fuel cell reaction, the diffusion of gases across the membrane is still substantial. This diffusion can be modeled as:

\dot{n}_{H}_{₂}=D_{eff}·t_{PEM}·(P_{H2,Anode}−P_{H2,Cathode}) (1)

Where \dot{n}_{H}_{₂} is the diffusion rate of hydrogen from the anode side to the cathode side of the stack 12, D_{eff} is the effective diffusion constant, t_{PEM} is the membrane thickness, P_{H2,Anode} is the partial pressure of hydrogen in the anode side of the stack 12, and P_{H2,Cathode} is the partial pressure of hydrogen in the cathode side of the stack 12.

During an idle-stop mode of the fuel cell system 10, which may be characterized as a time when little or no power is being drawn from the fuel cell stack 12, it is necessary to maintain a sufficient hydrogen partial pressure in the anode side of the fuel cell stack 12 to prevent damage that can occur as oxygen enters the anode side of the stack 12. An elevated hydrogen partial pressure in the anode side of the stack 12 will consume oxygen in the anode side. Based on the diffusion model of equation (1), described above, as time progresses, the hydrogen partial pressure in the cathode side of the stack 12 should begin to increase when there is no air flow in the cathode subsystem. As the hydrogen partial pressure increases, the driving force for hydrogen diffusion between the anode side and the cathode side of the stack 12 will decrease. In other words, it will require less hydrogen addition to the anode subsystem to maintain the desired partial pressure of hydrogen in the anode side of the stack 12.

In the case of a cathode valve failure, such as the failure of the cathode valve 22 or failure of the backpressure valve 24, the flow of cathode air through the cathode subsystem will not decrease during idle-stop conditions of the fuel cell system 10 because the partial pressure of hydrogen will not increase significantly in the cathode side of the fuel cell stack 12. By tracking the hydrogen added to the anode compartment during idle-stop conditions of the fuel cell system 10, a check can be performed to determine if the rate of hydrogen is low enough to indicate adequate sealing of the fuel cell system 10, particularly the cathode valve 22 and the backpressure valve 24.

Without adequate sealing, an algorithm of the fuel cell system, discussed in detail below, will indicate that a sealing issue must be addressed, but will not specify where exactly there is a sealing problem in the fuel cell system 10. While the sealing issue may be a cathode valve, it also may be a valve on the anode side, or it may not be caused by a faulty valve at all. The sealing issue could be caused by a leak in the plumbing of the anode subsystem, the cathode subsystem or it may be caused by leaks in various gaskets in the fuel cell stack.

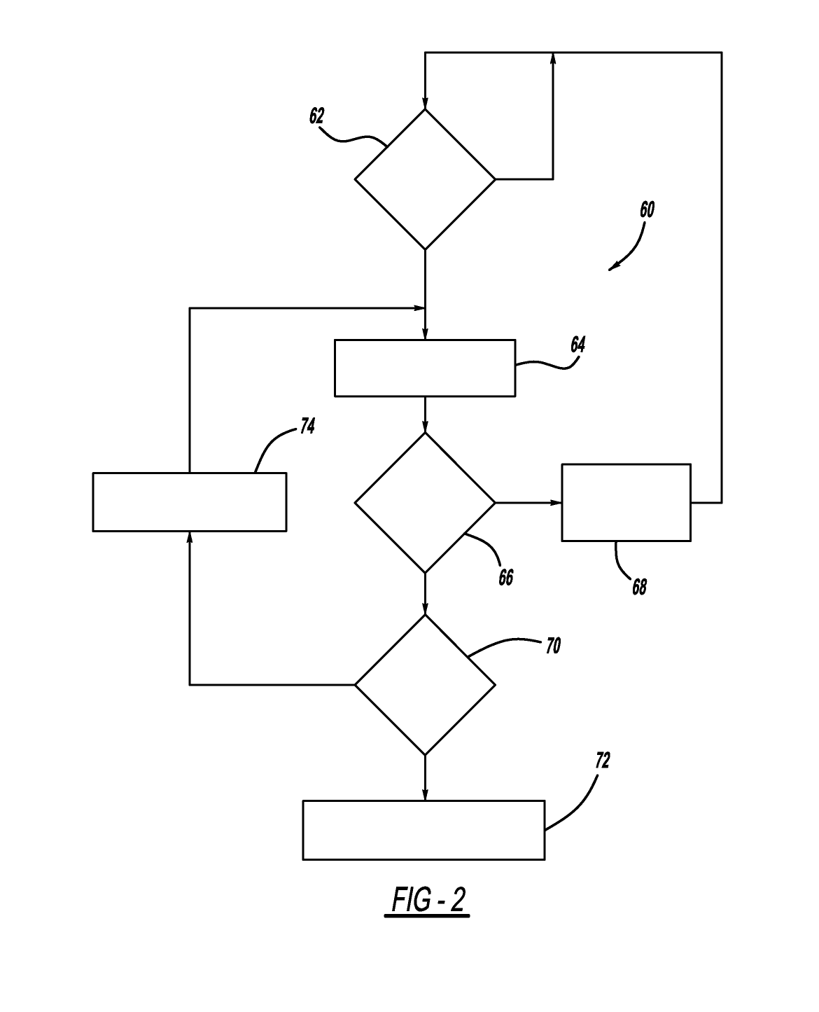

FIG. 2 is a flow diagram 60 of an algorithm for determining if there is a leak in the fuel cell system 10. The algorithm begins at decision diamond 62 by determining if an idle-stop condition of the fuel cell system 10 exists. If an idle-stop condition of the fuel cell system 10 does not exist, the algorithm will not take any action. If an idle-stop condition is determined to exist at the decision diamond 62, the algorithm determines the quantity of hydrogen added to the fuel cell system 10 during a period of time of the idle-stop condition at box 64. Next, the algorithm determines if the hydrogen added is greater than expected for the period of time during the idle-stop condition at decision diamond 66. The algorithm as described herein may be used more than once during a single idle-stop condition, thus, the evaluation of hydrogen consumption versus time in an idle-stop condition will be occurring often throughout the operation of the fuel cell system 10.

If the amount of hydrogen added is not determined to be greater than expected for the time during the idle-stop condition at the decision diamond 66, the diagnosis of the fuel cell system 10 ends at box 68 and the algorithm returns to the decision diamond 62. If the amount of hydrogen is greater than expected, the algorithm continues to decision diamond 70. At the decision diamond 70, the algorithm determines if the loop was evaluated more than a predetermined number of seconds during a previous period of time at the decision diamond 66. The algorithm also determines whether the hydrogen added to the fuel cell system 10 is greater than expected for the time the system 10 has been in the idle-stop condition. The algorithm further determines if a greater than expected amount of hydrogen has been previously determined during previous idle-stop conditions at decision diamond 70.

If the algorithm determines that the hydrogen added to the fuel cell system 10 is greater than expected, and a greater than expected amount of hydrogen has occurred during previous idle-stop conditions for greater than a predetermined failure threshold (quantity, duration or number of detections) at the decision diamond 70, then the algorithm sets a diagnostic trouble code for a reactant leak at box 72.

If the algorithm determines that the hydrogen added to the fuel cell system 10 is greater than expected, but the amount of hydrogen added to the system 10 does not exceed the maximum limit of idle-stop conditions, at the decision diamond 70, then the algorithm adapts the reactant concentration models for the change in expected system reactant leak due to the greater than expected amount of hydrogen added at box 74. The adapted reactant concentration models from the box 74 are then used by the algorithm to determine whether a greater than expected amount of hydrogen is added during the next evaluation of fuel cell system 10 idle-stop conditions at the box 66.

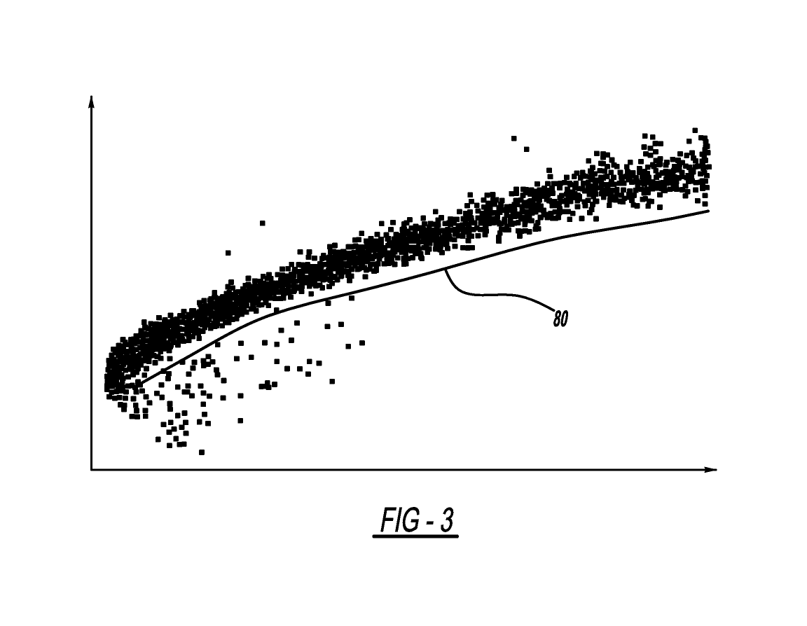

FIG. 3 is a graph with time in idle-stop conditions on the horizontal axis and inverse fuel consumption on the vertical axis, illustrating sample data to show when the algorithm as described in FIG. 2, above, detects that the amount of hydrogen added to the fuel cell system 10 is greater than expected. As shown in FIG. 3, the diagnostic trigger is a limit of rate of hydrogen added to the anode subsystem as a function of the time the fuel cell system 10 is in an idle-stop condition. The line 80 represents an allowable deviation line for the amount of hydrogen added to the anode subsystem. If the amount of hydrogen added falls above the line 80, then the algorithm determines that the amount of hydrogen added is acceptable. If the amount of hydrogen added falls below the line 80, then the algorithm determines that the amount of hydrogen consumed by the fuel cell system 10 is greater than expected.

To determine initial thresholds of valve performance, i.e., to determine threshold values for how much hydrogen addition would qualify as a greater than expected amount, testing and/or calibration with “limit” values may be used. A “limit” value is a valve that is known to have the upper limit of acceptable leak rate. Furthermore, the algorithm discussed above may be used to modify other control functions of the fuel cell system 10 to achieve improved performance of the fuel cell system 10. For example, the algorithm discussed above may trigger an adjustment in injection timing that is based on the change in the expected leak rate, to extend the period of time hydrogen is present in the fuel cell stack 12 after shutdown of the stack 12, as described in copending patent application Ser. No. 12/636,318, entitled, “Fuel Cell Operational Methods for Hydrogen Addition After Shutdown, filed Dec. 11, 2009, assigned to the assignee of this application and incorporated herein by reference.

In another example, the algorithm discussed above may trigger an adjustment of a determined anode side hydrogen concentration and an adjustment of a determined cathode side hydrogen concentration based on the leak rate determined by the algorithm above. The adjusted value of the anode and cathode hydrogen concentrations may then be used as an input for certain fuel cell system 10 functions, such as startup control functions and anode concentration control functions, as described in copending patent application Ser. No. 12/361,042, entitled, “System and Method for Observing Anode Fluid Composition During Fuel Cell System Start-Up,” filed Jan. 28, 2009, assigned to the assignee of this application and incorporated herein by reference.

In yet another example, the algorithm discussed above may trigger a modification of a standby mode operation, or may disable a standby mode operation, based on the leak rate determined by the algorithm above. For a more detailed description of modifying or disabling a standby mode operation, reference is made to copending patent application Ser. No. 12/336,193, entitled, “Method of Operating a Fuel Cell System in Standby/Regenerative Mode,” filed Dec. 16, 2008, assigned to the assignee of this application and incorporated herein by reference.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining if there is a potential leak of a reactant gas in a fuel cell system, said method comprising:
determining a quantity of hydrogen added to the fuel cell system for a given period of time during a predetermined operating condition of the fuel cell system;
determining whether the quantity of hydrogen added to the fuel cell system is more than a predetermined threshold amount of hydrogen;
determining if the quantity of hydrogen added has been more than the predetermined threshold amount of hydrogen for a predetermined number of times during previous predetermined operating conditions of the fuel cell system;
adapting an anode subsystem reactant gas concentration model and a cathode subsystem reactant gas concentration model if the quantity of hydrogen added to the fuel cell system is greater than the predetermined threshold amount and if the quantity of hydrogen added has been greater than the predetermined threshold amount for a predetermined number of times during previous predetermined operating conditions of the fuel cell stack to provide precise control of pressure in an anode subsystem and a cathode subsystem of the fuel cell system; and
setting a diagnostic trouble code indicating that the potential leak of the reactant gas in the fuel cell system is suspected if the quantity of hydrogen added to the fuel cell system is more than the predetermined threshold amount and if the quantity of hydrogen added has been more than the predetermined threshold amount for the predetermined number of times during previous predetermined operating conditions of the fuel cell stack.

2. The method according to claim 1 wherein setting a diagnostic trouble code includes indicating that cathode valves may not be functioning properly.

3. The method according to claim 1 wherein adapting the anode reactant gas concentration model includes using the adapted anode reactant concentration gas model to determine whether more than the predetermined threshold amount of hydrogen is added for a given period of time during a next predetermined operating condition of the fuel cell system.

4. The method according to claim 1 wherein the predetermined operating condition of the fuel cell system occurs when little or no power is being drawn from a fuel cell stack in the fuel cell system.

5. The method according to claim 1 further comprising triggering an adjustment of an injection of hydrogen from an injector that is based on the more than the predetermined threshold amount of hydrogen that has been added to the fuel cell system to provide the precise control of the pressure in the anode subsystem and the cathode subsystem of the fuel cell system.

6. The method according to claim 1 further comprising using the more than the predetermined threshold amount of hydrogen that has been added to the fuel cell system as an input for fuel cell system startup control functions and anode concentration control functions to provide the precise control of the pressure in the anode subsystem and the cathode subsystem of the fuel cell system.

7. The method according to claim 1 further comprising triggering a modification of a standby mode operation and/or disabling a standby mode operating based on the more than the predetermined threshold amount of hydrogen that has been added to the fuel cell system to provide the precise control of the pressure in the anode subsystem and the cathode subsystem of the fuel cell system.

8. A method for quantifying an amount of hydrogen added to a fuel cell system to determine if there is a potential leak of a reactant gas in the fuel cell system, said method comprising:
determining a quantity of hydrogen added to the fuel cell system for a given period of time during a predetermined operating condition of the fuel cell system;
determining whether the quantity of hydrogen added to the fuel cell system is more than a predetermined threshold amount of hydrogen;
determining if the quantity of hydrogen added has been more than the predetermined threshold amount of hydrogen for a predetermined number of times during previous predetermined operating condition of the fuel cell system;
adapting an anode subsystem reactant gas concentration model and a cathode subsystem reactant gas concentration model if the quantity of hydrogen added to the fuel cell system is more than the predetermined threshold amount and if the quantity of hydrogen added has been more than the predetermined threshold amount for a predetermined number of times during previous predetermined operating conditions of the fuel cell system;
setting a diagnostic trouble code indicating that the potential leak of the reactant gas in the fuel cell system is suspected if the quantity of hydrogen added to the fuel cell system is more than the predetermined threshold amount and if the quantity of hydrogen added has been more than the predetermined threshold amount for the predetermined number of times during previous predetermined operating conditions of the fuel cell stack; and
utilizing the adapted anode reactant gas concentration model to determine whether more than the predetermined threshold amount of hydrogen is added for a given period of time during a next predetermined operating condition of the fuel cell system.

9. The method according to claim 8 wherein setting a diagnostic trouble code includes indicating that cathode valves may not be functioning properly.

10. The method according to claim 8 wherein setting a diagnostic trouble code includes indicating that an anode valve, anode subsystem plumbing, cathode subsystem plumbing or gaskets in a fuel cell stack may be leaking.

11. The method according to claim 8 wherein the predetermined operating condition of the fuel cell system occurs when little or no power is being drawn from a fuel cell stack in the fuel cell system.

12. The method according to claim 8 further comprising triggering an adjustment of an injection of hydrogen from an injector that is based on the more than the predetermined threshold amount of hydrogen that has been added to the fuel cell system to provide the precise control of the pressure in the anode subsystem and the cathode subsystem of the fuel cell system.

13. The method according to claim 8 further comprising using the more than the predetermined threshold amount of hydrogen that has been added to the fuel cell system as an input for fuel cell system startup control functions and anode concentration control functions to provide the precise control of the pressure in the anode subsystem and the cathode subsystem of the fuel cell system.

14. The method according to claim 8 further comprising triggering a modification of a standby mode operation and/or disabling a standby mode operating based on the more than the predetermined amount of hydrogen that has been added to the fuel cell system to provide the precise control of the pressure in the anode subsystem and the cathode subsystem of the fuel cell system.

15. A method for determining if more hydrogen has been added to a fuel cell system than a predetermined threshold amount to detect leaks in an anode subsystem or a cathode subsystem of the fuel cell system, said method comprising:
determining a quantity of hydrogen added to the fuel cell system for a given period of time during a predetermined operating condition of the fuel cell system;
determining whether the quantity of hydrogen added to the fuel cell system is greater than the predetermined threshold amount; and
adapting an anode subsystem reactant gas concentration model and a cathode subsystem reactant gas concentration model if the quantity of hydrogen added to the fuel cell system is more than the predetermined threshold amount to provide precise control of pressure in the anode subsystem and the cathode subsystem of the fuel cell system.

16. The method according to claim 15 further comprising determining if the quantity of hydrogen added has been more than the predetermined threshold amount for a predetermined number of times during previous predetermined operating conditions of the fuel cell system.

17. The method according to claim 16 further comprising a diagnostic trouble code that is triggered if the quantity of hydrogen added has been more than the predetermined threshold amount for the predetermined number of times.

18. The method according to claim 17 wherein setting the diagnostic trouble code includes indicating that cathode valves may not be functioning properly.

19. The method according to claim 15 wherein adapting the anode reactant gas concentration model includes using the adapted anode reactant gas concentration model to determine whether more than the predetermined threshold amount of hydrogen is added for a given period of time during a next predetermined operating condition of the fuel cell system.

20. The method according to claim 15 wherein the predetermined operating condition of the fuel cell system occurs when little or no power is being drawn from a fuel cell stack in the fuel cell system.
